(19) United States
(12) Patent Application Publication
(10) Pub. No.: US 2007/0101774 A1
(43) Pub. Date: May 10, 2007

(54) Washing machine

(76) Inventor: Kyu Hwan Lee, Busan (KR)

Correspondence Address: KED & ASSOCIATES, LLP, P.O. Box 221200, Chantilly, VA, 20153-1200, US

(21) Appl. No.: 11/476,935

(22) Filed: Jun. 29, 2006

(30) Foreign Application Priority Data
Jun. 30, 2005 (KR) 10-2005-0057824

(51) Int. Cl. D06F 25/00; D06F 37/00; B08B 3/12

(52) U.S. Cl. 68/208; 68/139; 68/3 R

(57) ABSTRACT

A washing machine is disclosed, in which a drain hose is fixed to the washing machine so as not to generate noise while the drain hose is in contact with parts around the drain hose during a washing stroke. The washing machine comprises a tub receiving water, a drum rotatably provided inside the tub, a cabinet provided with the tub therein, a drain hose connected with the tub to guide the water received in the tub toward the outside of the cabinet, a holder having an opened side to fit the drain hose into the opened side, a cover extended from any one end of the opened side of the holder and bent around the one end to close and open the opened side of the holder, and a fixing portion provided at a side of the holder, fixing the holder to the cabinet. Since the drain hose is not detached from the fixing device during a washing stroke and is prevented from being moved inside the fixing device, it is possible to avoid noise generated due to contact between the drain hose and parts of the washing machine.

This application claims the benefit of Korean Application No. 10-2005-0057824, filed on Jun. 30, 2005, which is hereby incorporated by reference as if fully set forth herein.

### BACKGROUND OF THE INVENTION

1. Field of the Invention

The present invention relates to a washing machine, and more particularly, to a fixing device for a drain hose of a washing machine, in which the drain hose is fixed to the washing machine so as not to generate noise while the drain hose is in contact with parts around the drain hose during a washing stroke.

2. Discussion of the Related Art

In general, examples of a washing machine include a pulsator type washing machine and a drum washing machine. The pulsator type washing machine executes a washing stroke using a water stream generated by rotation of a plate type pulsator. The drum washing machine executes a washing stroke using head drop and a frictional force between washing water and the laundry, generated by rotation of a tub laid in a horizontal direction.

Consumer demand of the drum washing machine is on an increasing trend owing to its advantages of small quantity of water and detergent, small damage of cloth, and little entanglement of laundries.

A related art drum washing machine will be described with reference to FIG. 1. Referring to FIG. 1, the related art drum washing machine includes a cabinet 2 constituting a main body 1, a cylindrical tub 3 horizontally supported inside the cabinet 2, a drum 4 rotatably provided inside the tub 3, and a drive motor 5 driving the drum 4.

Meanwhile, a drain hose 6 is provided at a lower side of the tub 3 to drain out washing water after completing a washing stroke. The drain hose 6 communicates with the drum 4 and the tub 3 and is externally extended from a rear surface of the cabinet 2. A drain pump 7 is provided on the bottom of the main body 1 on the extension of the drain hose 6 to forcibly pump the washing water inside the drum 4, whereby the washing water is drained out.

At this time, the drain hose 6 is connected with the lower end of the tub 3 so that it can be drawn out of an upper side of the cabinet 2.

This is to prevent the washing water inside the drum 4 from being rapidly drained out in case of an unintended power-off state such as power failure. To this end, the washing water is guided toward a higher level than a water level inside the drum 4 and then is drained out toward the lower side of the drum 4.

In this case, a fixing device 8 is provided to fix a middle portion of the drain hose 6 to an inner side of the cabinet 2, thereby preventing the drain hose 6 from being bent toward the inner side of the drum washing machine 1 due to self-load of the drain hose 6 or sagging toward the lower side of the cabinet 2.

Meanwhile, the drain hose 6 extended to the outside of the drum washing machine 1 is fixed to the outside of the cabinet 2 by a clamp 9.

As shown in FIG. 2, the related art fixing device 8 includes a holder 81 fixed to the outside of the drain hose 6, and a fixing portion 82 fixing the fixing device 8 to the cabinet 2.

The holder 81 has an inner diameter the same as or similar to an outer diameter of the drain hose 6. The holder 81 is provided with an opening 81a at one side to allow the drain hose 6 to come in and out.

Also, the holder 81 is provided with an inclined plane 81b to facilitate coming in and out of the drain hose 6 through the opening 81a. In this case, the opening 81a has a width smaller than the outer diameter of the drain hose 6.

The fixing device 8 is fixed to the middle portion of the cabinet 2 at a rear surface of the drum washing machine 1 by the fixing portion 82. The drain hose 6 is guided to the inclined plane 81b and then inserted into the holder 81, whereby the drain hose 6 is fixed to the fixing device 8.

However, the related art fixing device 8 for the drain hose has several problems.

To control the length of the drain hose 6, if a user forcibly pushes the drain hose 6, which is exposed to the outside of the cabinet 2, toward the inner side of the cabinet 2 or pulls out the drain hose 6, the drain hose 6 is easily detached from the fixing device 8 through the opening 81a.

Also, the drain hose 6 detached from the fixing device 8 may be bent or sagged by self-load. In this case, the drain hose 6 may be in contact with the inner side of the cabinet 2 of the drum washing machine 1 or may be inserted into a damper (not shown) connected with the lower side of the cabinet 2 and the tub 3. For this reason, noise is generated among the drain hose 6, the cabinet 2 and the damper during the washing stroke, especially a dehydrating stroke that greatly generates vibration due to high-speed rotation of the drum 4.

### SUMMARY OF THE INVENTION

Accordingly, the present invention is directed to a washing machine that substantially obviates one or more problems due to limitations and disadvantages of the related art.

An object of the present invention is to provide a washing machine in which a drain hose is fixed to the washing machine so as not to generate noise while the drain hose is in contact with parts around the drain hose during a washing stroke.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a washing machine according to the present invention comprises a tub receiving water, a drum rotatably provided inside the tub, a cabinet provided with the tub therein, a drain hose connected with the tub to guide the water received in the tub toward the outside of the cabinet, a holder having an opened side to fit the drain hose into the opened side, a cover extended from any one end of the opened side of the holder and bent around the one end to close and open the opened side of the holder, and a fixing portion provided at a side of the holder, fixing the holder to the cabinet.

Preferably, the holder has a ring shape, and has an inner diameter smaller than an outer diameter of the drain hose.

Preferably, the drain hose is provided with bellows on its outer circumference, and the holder is provided with ribs on its inner circumference, wherein the ribs are interposed between the respective bellows of the drain hose to prevent the drain hose from being moved up and down.

Preferably, a portion where the end of the side of the holder joins with the cover is formed of a bent portion thinner than the holder.

Preferably, the cover further includes a movement stopper preventing movement of the drain hose, wherein the movement stopper is extended from an inner side of the cover to limit the inner diameter of the holder.

Preferably, one side of the movement stopper is in contact with the drain hose and has a rounded curve.

Preferably, the opened side of the holder is provided with a connection hook portion at the other end, and the cover is provided with a fitting portion fixed to the connection hook portion.

Preferably, the connection hook portion is comprised of a hook extended from the other end, and the fitting portion is a fitting hook hooked in the hook.

Preferably, the opened side of the holder is provided with an inclined plane opened toward the outside at each end, and the cover is bent around any one end of the inclined plane.

Preferably, the fixing portion is arranged in a vertical direction to the opened side of the holder.

Preferably, the cabinet includes a hook hole, and the fixing portion includes an extension extended from the side of the holder and a hook fitted into the hook hole.

Preferably, the extension includes a stopper externally extended from both sides of the extension to prevent the hook from being excessively inserted into the hook hole.

Preferably, the washing machine further comprises a reinforcing rib formed on an outer circumference of the holder.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a sectional view illustrating a related art drum washing machine;

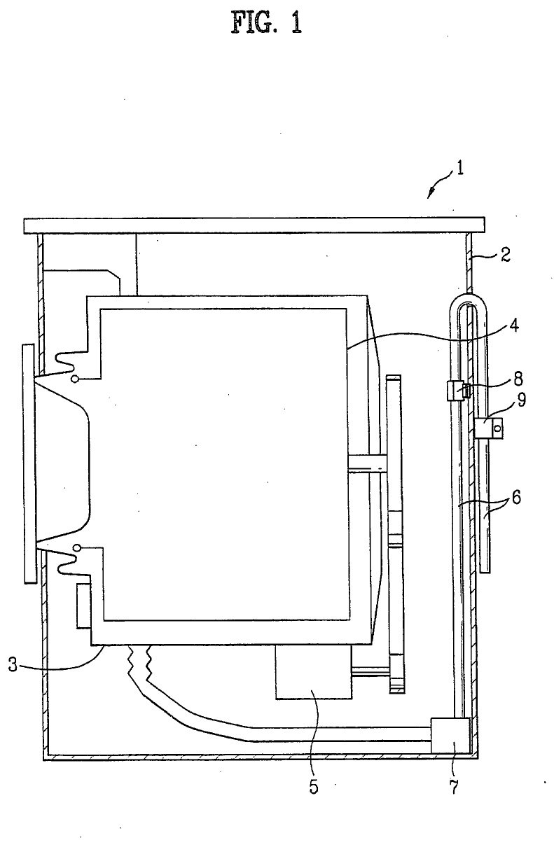

FIG. 2 is a perspective view illustrating a drain hose and a fixing device for the drain hose according to the related art drum washing machine;

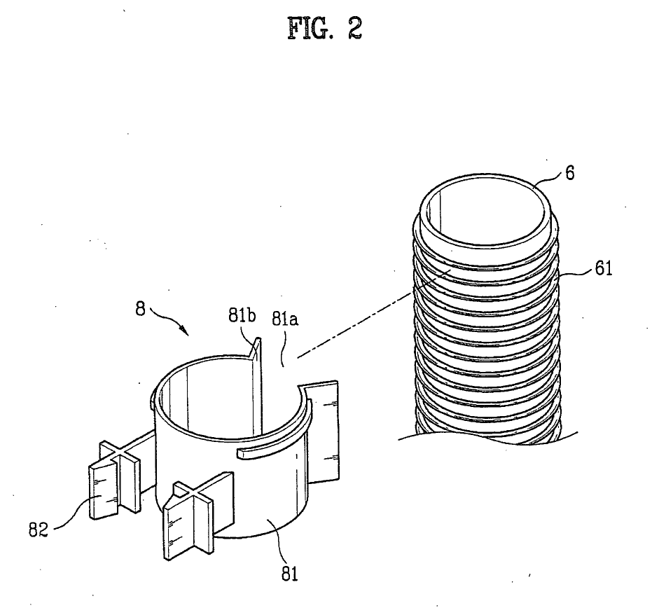

FIG. 3 is a sectional view illustrating the state that a fixing device for a drain hose is fixed to a drum washing machine according to the preferred embodiment of the present invention;

FIG. 4 is a perspective view illustrating a drain hose and a fixing device for the drain hose according to the preferred embodiment of the present invention; and

FIG. 5 is a sectional view illustrating the state that a fixing device for a drain hose is fixed to a cabinet of a drum washing machine according to the preferred embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

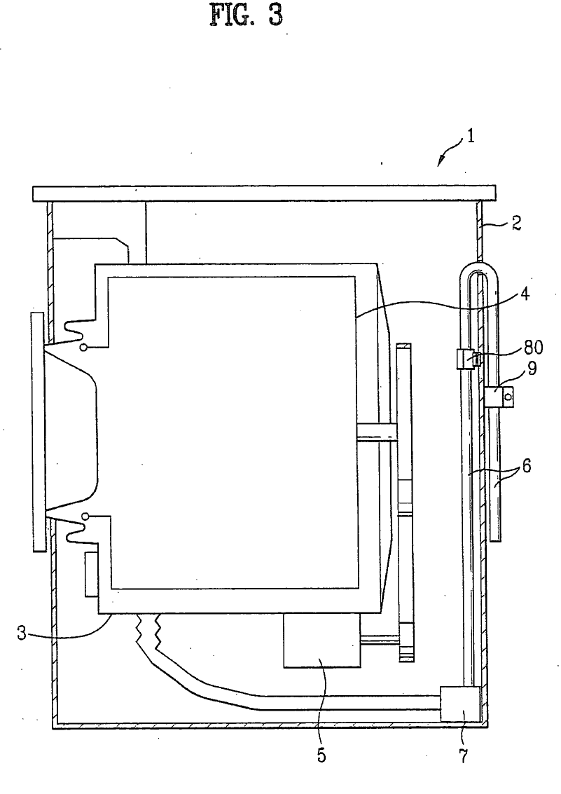

Hereinafter, a fixing device for a drain hose of a drum washing machine according to the preferred embodiment of the present invention will be described in detail with reference to FIG. 3 to FIG. 5.

For reference, the same reference numbers will be used throughout the drawings according to the present invention to refer to the same parts as those of the related art drum washing machine.

As shown in FIG. 3, one side of a drain hose 6 provided inside a cabinet 2 of a drum washing machine 1 is fixed to an inner side of the cabinet 2 of the drum washing machine 1 by a fixing device 80. On the other hand, the other side of the drain hose 6 extended to the outside of the cabinet 2 of the drum washing machine 1 is fixed to the outside of the cabinet 2 by a clamp 9.

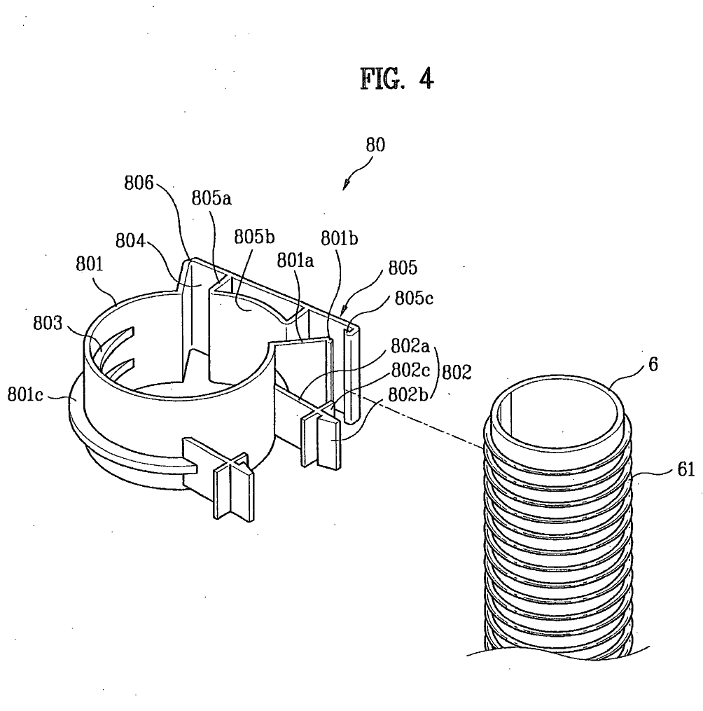

The fixing device according to the preferred embodiment of the present invention will be described in detail with reference to FIG. 4.

The fixing device includes a holder 801 provided with an opening 804 into which the drain hose 6 having bellows 61 is fitted, a fixing portion 802 fixing the holder 801 to the cabinet 2, and a cover 805 covering the opening 804 of the holder 801.

Preferably, the holder 801 has an inner diameter smaller than an outer diameter of the drain hose 6 so that the drain hose 6 having the bellows 61 formed on its outer circumference can firmly be fixed to the holder 801.

Furthermore, the holder 801 is provided with ribs 803 on its inner circumference, wherein the ribs 803 are interposed between the respective bellows 61 to prevent the drain hose 6 to move up and down.

At this time, it is preferable that the ribs 803 have lower and upper widths in the range that they are interposed between the respective bellows 61 of the drain hose 6 so as not to generate movement of the drain hose 6. More preferably, at least one or more ribs 803 are formed.

Also, it is preferable that among opened sides of the holder 801, each end side is provided with an inclined plane 801a externally opened to allow the drain hose 6 to be desirably come in and out the holder 801 through the opening 804.

The cover 805 is extended from any one end side of the inclined plane 801a among the opened sides of the holder 801 and is bent around the end side to open and close the opened portion of the holder 801.

At this time, the end side of the inclined plane 801a and the portion where the cover 805 is bent are preferably comprised of a bent portion 806 thinner than the holder 801 to facilitate bending of the cover 805.

Furthermore, a connection hook 801b is formed at the other end side of the inclined plane 801a among the opened sides of the holder 801, and the cover 805 is provided with a fitting portion 805c fixed to the connection hook 801b.

At this time, it is preferable that the connection hook 801b is comprised of a hook 801b extended from the end side of the inclined plane 801a, and the fitting portion 805c is comprised of a fitting hook fitted to the hook 801b.

The fixing portion 802 serves to fix the holder 801 to the cabinet of the drum washing machine.

Furthermore, the fixing portion 802 is preferably arranged at the side vertical to the opened portion of the holder 801 among the sides of the holder 801. This structure means that the opened portion of the holder 801 into which the drain hose 6 is fitted is arranged in a vertical direction to the cabinet 2 when the holder 801 is fixed to the cabinet 2.

In other words, the opened portion of the holder 801 is arranged laterally to the holder 801 around the fixing portion 802, so that the drain hose 6 can act a restoring force generated in an opposite direction from the cabinet on the holder 801 not the cover 805 to improve a fitting force of the cover 805.

Furthermore, the fixing portion 802 is comprised of a pair of extensions 802a extended from the side of the holder 801. Preferably, each end of the extensions 802a has a hook shape 802b constituting an inclined plane toward the inner side from the extension 802a, whereby each end of the extensions 802a is smoothly fitted into a hook hole 21 formed in the cabinet 2 of the drum washing machine 1.

At this time, each of the extensions 802a of the fixing portion 802 is provided with stoppers 802c extended vertically to the extension 802a at both sides of the extension 802a to prevent the extension 802a from being excessively fitted into the hook hole 21.

Preferably, the interval between the stopper 802c and the hook 802b is almost the same as the thickness of the cabinet 2.

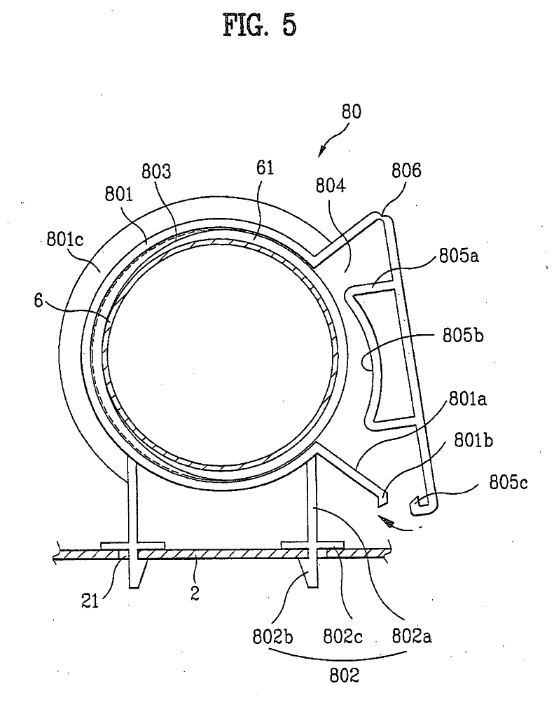

The state that the drain hose of the drum washing machine is fixed to the cabinet of the drum washing machine through the fixing device according to the preferred embodiment of the present invention will be described in detail with reference to FIG. 5.

First, the fixing portion 802 is fixed to the hook hole 21 formed at the middle portion of the cabinet 2 to fix the holder 801 to the cabinet 2. At this time, the stopper 802c prevents the fixing portion 802 from being excessively inserted into the hook hole 21. Thus, the fixing portion 802 can firmly be fixed to the hook hole 21 of the cabinet 2 without excessive insertion to the hook hole 21.

Next, the drain hose 6 is inserted into the holder 801 through the opened portion formed in a lateral direction of the holder 801.

In this case, the opened portion of the holder 801 is forcibly opened due to the outer diameter of the drain hose 6, which is greater than the width of the opened portion of the holder 801. For this reason, the drain hose 6 is inserted into the holder 801, whereby the drain hose 6 can firmly be fixed to the holder 801.

Furthermore, the ribs 803 formed on the inner circumference of the holder 801 are fitted between the respective bellows 61 formed on the outer circumference of the drain hose 6 fitted into the holder 801 as described above. Therefore, it is possible to prevent the drain hose 6 from being moved up and down.

Next, the cover 805 is bent toward the inner side of the holder 801 around the bent portion 806 so that the hook 805c formed at the end of the cover 805 is fixed to the hook 801b formed at the end of the inclined plane 801a.

At this time, a movement stopper 805a is formed at the inner side of the cover 805 to prevent the drain hose 6 from being moved up and down. The movement stopper 805a pressurizes the outer circumference of the drain hose 6 so that the drain hose 6 can more firmly be fixed to the holder 801. Preferably, the movement stopper 805a is comprised of a hollow space that can elastically pressurize the outer circumference of the drain hose 6 in accordance with the outer diameter of the drain hose 6.

Meanwhile, in order to detach the drain hose 6 from the fixing device 80, the operation contrary to the aforementioned fixing operation is executed. First, the fitting hook 805c is detached from the hook 801b of the cover 805. At this time, the cover 805 is unfolded around the bent portion 806 due to its elasticity to open the opened portion of the holder 801. The drain hose 6 is externally detached from the fixing device through the opened portion of the holder 801.

As described above, since the drain hose 6 is firmly be fixed to the fixing device 80, it is possible to avoid noise that may be generated as the drain hose 6 is in contact with the cabinet 2 and the damper during a washing stroke.

Meanwhile, it is preferable that a reinforcing rib 801c is further formed on the outer circumference of the holder 801 to reinforce strength of the holder 801.

As described above, the washing machine according to the preferred embodiment of the present invention has the following advantages.

Since the drain hose is not detached from the fixing device during the washing stroke and is prevented from being moved inside the fixing device, it is possible to avoid noise generated due to contact between the drain hose and parts of the washing machine.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A washing machine comprising:
a tub receiving water;
a drum rotatably provided inside the tub;
a cabinet provided with the tub therein;
a drain hose connected with the tub to guide the water received in the tub toward the outside of the cabinet;
a holder having an opened side to fit the drain hose into the opened side;
a cover extended from any one end of the opened side of the holder and bent around the one end to close and open the opened side of the holder; and
a fixing portion provided at a side of the holder, fixing the holder to the cabinet.

2. The washing machine as claimed in claim 1, wherein the holder has a ring shape, and has an inner diameter smaller than an outer diameter of the drain hose.

3. The washing machine as claimed in claim 2, wherein the drain hose is provided with bellows on its outer circumference, and the holder is provided with ribs on its inner circumference, the ribs being interposed between the respective bellows of the drain hose to prevent the drain hose from being moved up and down.

4. The washing machine as claimed in claim 1, wherein a portion where the end of the side of the holder joins with the cover is formed of a bent portion thinner than the holder.

5. The washing machine as claimed in claim 1, wherein the cover further includes a movement stopper preventing movement of the drain hose, the movement stopper being extended from an inner side of the cover to limit the inner diameter of the holder.

6. The washing machine as claimed in claim 5, wherein one side of the movement stopper is in contact with the drain hose and has a rounded curve.

7. The washing machine as claimed in claim 1, wherein the opened side of the holder is provided with a connection hook portion at the other end, and the cover is provided with a fitting portion fixed to the connection hook portion.

8. The washing machine as claimed in claim 7, wherein the connection hook portion is comprised of a hook extended from the other end, and the fitting portion is a fitting hook hooked in the hook.

9. The washing machine as claimed in claim 1, wherein the opened side of the holder is provided with an inclined plane opened toward the outside at each end, and the cover is bent around any one end of the inclined plane.

10. The washing machine as claimed in claim 1, further comprising a reinforcing rib formed on an outer circumference of the holder.

11. The washing machine as claimed in claim 1, wherein the fixing portion is arranged in a vertical direction to the opened side of the holder.

12. The washing machine as claimed in claim 10, wherein the cabinet includes a hook hole, and the fixing portion includes an extension extended from the side of the holder and a hook fitted into the hook hole.

13. The washing machine as claimed in claim 12, wherein the extension includes a stopper externally extended from both sides of the extension to prevent the hook from being excessively inserted into the hook hole.
